(19) United States
(12) Patent Application Publication
(10) Pub. No.: US 2025/0160370 A1
(43) Pub. Date: May 22, 2025

(54) BEVERAGE COMPOSITIONS FOR HYDRATION AND FOR SUPPORT OF HAIR HEALTH

(71) Applicant: CELMATRIX CORPORATION, Henderson, NV (US)

(72) Inventor: SHAHIN SHANE MALEK, Henderson, NV (US)

(21) Appl. No.: 18/513,527

(22) Filed: Nov. 18, 2023

(51) Int. Cl. A23L 2/52; A23L 29/00; A23L 33/00; A23L 33/15

(52) U.S. Cl. CPC A23L 2/52; A23L 29/015; A23L 33/15; A23L 33/40

(57) ABSTRACT

A beverage composition for hydration and for supporting head hair health is described. The beverage composition includes (i) amla and (ii) one or more head hair benefit ingredient(s). Head hair benefit ingredient(s) in the beverage composition may include trace elements such as zinc, calcium, and selenium, among others; and vitamins such as: vitamin A; vitamin B, e.g., riboflavin, biotin, folate, thiamine, niacin, pantothenic acid, pyridoxine, and cobalamins, etc.; vitamin C; vitamin D; vitamin E; and vitamin K. The beverage compositions of the present disclosure in addition to supporting head hair health and promoting growth of head hair have also been found to be beneficial to support health of skin and nails.

### FIELD

The present disclosure generally relates to compositions for support of hair health, and to beverage compositions for hydration and for support of hair health, as for example the promotion of hair growth.

### DESCRIPTION OF THE RELATED ART

A large number of topically applied hair growth compositions are known in the art, utilizing a variety of active ingredients for promoting hair growth of persons who suffer from hair loss. There also exist many different types of shampoos, conditioners, and hair rinses that are formulated for topical application to the hair to support hair health and beauty.

Various disadvantages of topically applied hair benefit compositions include adverse dermatological and systemic side effects, lengthy times and inconvenient application requirements for topical contacting with the hair benefit composition to achieve the desired enhancement effect, and the presence in many products of ingredients that are not environmentally benign.

### SUMMARY

The present disclosure relates broadly to compositions for human consumption for support of hair health, as for example aqueous beverage compositions for human consumption for hydration and for support of hair health including promotion of hair growth.

In one aspect, the disclosure relates to a composition for support of head hair health, comprising (i) amla and (ii) one or more head hair benefit ingredient(s).

In another aspect, the disclosure relates to a beverage composition for hydration and support of head hair health, comprising (i) amla and (ii) one or more head hair benefit ingredient(s), in an aqueous beverage medium.

In another aspect, the disclosure relates to a beverage composition for hydration and for support of head hair health, comprising amla; zinc; selenium; vitamins A-E; and water.

In a further aspect, the disclosure relates to a method of concurrently mediating hydration and head hair health of a human subject in need thereof, the method comprising administering to the human subject a beverage composition of the present disclosure.

Other aspects, features and embodiments of the disclosure will be more fully apparent from the ensuing description and appended claims.

### DETAILED DESCRIPTION

The present disclosure generally relates to compositions for support of hair health, including beverage compositions for hydration and for support of head hair health.

As used herein and in the appended claims, the singular forms “a”, “an”, and “the” include plural referents unless the context clearly dictates otherwise.

As used herein and in the appended claims, “amla” is an extract from the fruit of the Emblica officinalis plant, containing polyphenols, e.g., ellagic acid, chebulinic acid, gallic acid, chebulagic acid, apeigenin, quercetin, corilagin, and leutolin, as well as hydrolysable tannins. Amla may be employed in the beverage compositions of the present disclosure in any suitable concentrations or amounts, and may be formulated into such beverage compositions in any appropriate ingredient form, such as for example in the form of a paste, oil, juice, or powder derived from such plant from the fruit of the Emblica officinalis plant.

In the beverage compositions of the present disclosure, amla and other ingredients hereinafter described are advantageously solubilized in a suitable beverage medium, which may for example be or comprise water or other aqueous beverage medium, and in various embodiments may be or comprise any of coffees, teas, milks, juices, colas, and the like.

In all compositions of the present disclosure, all ingredients are present in respective physiologically acceptable amounts for human consumption.

In various embodiments, amla is present in beverage compositions of the present disclosure in an amount of from 0.1 wt % to 5% wt %, based on the total weight of the composition, and in specific formulations of the beverage compositions may be present in an amount of from 0.25 wt % to 5 wt %, or from 0.5 to 4 wt %, or from 0.5 wt % to 2.5 wt %, on the same total weight basis of the composition, although the disclosure is not limited thereto, and other beverage composition amounts of amla may be usefully employed in the broad practice of the present disclosure.

In the compositions of the present disclosure, amla is formulated with one or more physiologically acceptable head hair benefit ingredient(s), i.e., ingredients that support and promote hair health. The hair benefit ingredient(s) may for example include any one or more of: trace elements such as zinc, calcium, and selenium, among others, and/or oxides and/or salts (e.g., citrate, chloride, sodium, and sulfate salts) thereof; vitamins such as: vitamin A; vitamin B, e.g., riboflavin, biotin, folate, thiamine, niacin, pantothenic acid, pyridoxine, and cobalamins, etc.; vitamin C; vitamin D; vitamin E; and vitamin K; plant extracts such as any one or more of ashwagandha, reishi mushroom, lion's mane mushroom, holy basil, turmeric root, raspberry juice concentrate, natural flavors, stevia extract, vegetable glycerine, potassium sorbet, and citric acid; and may include any other hair benefit ingredient(s) that are physiologically acceptable for human consumption and that in the composition function to support head hair health, e.g., to promote head hair growth and healthy head hair characteristics. Trace metal elements such as zinc and selenium have been found to be particularly advantageous in various embodiments of the beverage compositions.

The beverage compositions of the present invention, for hydration and for support of head hair health, may thus be formulated as comprising (i) amla and (ii) one or more head hair benefit ingredient(s), e.g., one or more head hair benefit ingredient(s) comprising one or more selected from the group consisting of: head hair benefit trace metal elements and oxides and salts thereof; and head hair benefit vitamins, with such ingredients (i) and (ii) being solubilized in a suitable physiologically acceptable beverage medium, such as water or other aqueous beverage medium, or other beverage medium.

The ingredients (i) and (ii) of the beverage composition may be provided or processed in a form in which when blended with water form a clear liquid beverage solution.

The beverage compositions of the present disclosure may be formulated by blending soluble ingredients including ingredients (i) and (ii) into water or other beverage medium.

The beverage compositions of the present disclosure in other embodiments may comprise amla and one or more plant extracts such as ashwagandha, reishi mushroom, lion's mane mushroom, holy basil, turmeric root, raspberry juice concentrate, natural flavors, stevia extract, vegetable glycerine, potassium sorbet, and citric acid, in a beverage medium such as water or other aqueous beverage medium, or other beverage medium. Such beverage compositions may additionally comprise one or more selected from the group consisting of: head hair benefit trace metal elements and oxides and salts thereof; and head hair benefit vitamins, e.g., any one or more of vitamins A-E.

Any of the various beverage compositions described above may further comprise chromium and iodine.

The beverage compositions of the present disclosure in addition to supporting head hair health and promoting growth of head hair have also been found to be beneficial to support health of skin and nails.

In various preferred embodiments of the beverage composition, the beverage composition comprises amla, zinc, selenium, and one or more vitamins. In such compositions, the selenium may be in an amount of from 10 to 150 μg, but the disclosure is not limited thereto, and other selenium amounts or concentrations may be employed within the broad practice of the present disclosure. Zinc may be present in such compositions in an amount of from 5 to 40 mg, but the disclosure is not limited thereto, and other selenium amounts or concentrations may be employed within the broad practice of the present disclosure. The vitamins in the composition may be of any suitable type, and may for example comprise one or more of vitamins A, B, C, D, and E. In various embodiments, the vitamins in the composition include riboflavin and biotin.

As an illustrative specific embodiment, the beverage composition may comprise amla, selenium, zinc, and vitamins A-E in aqueous beverage medium.

As a further illustrative specific embodiment, the beverage composition may comprise the composition set out below having the following weight percentages of the respective ingredients, wherein the respective weight percentages are based on the total weight of the composition, and the total weight percentages of all ingredients in the composition is 100 weight percent:

| Ingredient | Weight Percent |
|---|---|
| chromium | 0.00022% |
| iodine | 0.00055% |
| selenium | 0.00022% |
| zinc | 0.00660% |
| vitamin A | 0.00055% |
| vitamin B | 0.00726% |
| vitamin C | 0.02200% |
| vitamin D | 0.00002% |
| vitamin E | 0.00220% |
| blend* | 1.96038% |
| Water | 98.0000.% |
| TOTAL | 100 weight percent |

*blend of plant extracts ashwagandha, reishi mushroom, lion's mane mushroom, holy basil, turmeric root, raspberry juice concentrate, natural flavors, stevia extract, vegetable glycerine, potassium sorbet, and citric acid.

The beverage composition of the present disclosure may be provided in a suitable packaged form, comprising packaging containing the beverage composition, such as for example containing a single serving amount of the beverage composition, e.g., as a bottled or canned volume of 6 to 12 fluid ounces, or more, or as a multiple servings amount of the beverage composition, e.g., as a bottled or canned volume of 16 to 32 fluid ounces, or in other suitable volumes and packaged forms.

The present disclosure in a method aspect relates to a method of concurrently mediating hydration and head hair health of a human subject in need thereof, such method comprising administering to the human subject an aqueous beverage composition of the present disclosure. The present disclosure in such respect provides a drink composition that is efficacious for hydration of a consumer thereof, while simultaneously providing head hair health benefit to such consumer.

Beverage compositions of the present disclosure containing amla, selenium, zinc, and vitamins have been found to mediate enhanced growth of head hair in human subjects consuming such beverage compositions for sustained periods of 4-6 weeks, as compared to human subjects not consuming the beverage compositions but otherwise having substantially similar dietary, sleep, and exercise activity to the subjects consuming such beverage compositions.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

What is claimed is:

1. A composition for support of head hair health, comprising (i) amla and (ii) one or more head hair benefit ingredient(s).

2. The composition of claim 1, wherein the one or more head hair benefit ingredient(s) comprise one or more selected from the group consisting of: head hair benefit trace metal elements and oxides and salts thereof; and head hair benefit vitamins.

3. The composition of claim 2, wherein head hair benefit trace metal(s) of the head hair benefit trace metal elements and oxides and salts thereof comprises at least one of zinc, calcium, and selenium.

4. The composition of claim 3, wherein the salts of the head hair benefit trace metal elements comprise citrate, chloride, sodium, or sulfate salts.

5. The composition of claim 1, wherein the one or more head hair benefit ingredient(s) comprises zinc.

6. The composition of claim 5, wherein the amount of zinc is in a range of from 5 to 40 mg.

7. The composition of claim 1, wherein the one or more head hair benefit ingredient(s) comprises selenium.

8. The composition of claim 7, wherein the amount of selenium is in a range of from 10 to 150 μg.

9. The composition of claim 1, wherein the one or more head hair benefit ingredient(s) comprises zinc and selenium.

10. The composition of claim 1, wherein the one or more head hair benefit ingredient(s) comprises one or more head hair benefit vitamin(s).

11. The composition of claim 10, wherein the head hair benefit vitamin(s) comprise one or more selected from the group consisting of vitamin A; vitamin B; vitamin C; vitamin D; vitamin E; and vitamin K.

12. The composition of claim 10, wherein the one or more head hair benefit vitamin(s) comprise one or more selected from the group consisting of riboflavin, biotin, folate, thiamine, niacin, pantothenic acid, pyridoxine, and cobalamins.

13. The composition of claim 10, wherein the one or more head hair benefit vitamin(s) comprise riboflavin and biotin.

14. The composition of claim 1, comprising a beverage medium in which the amla and the one or more head hair benefit ingredient(s) are solubilized.

15. The composition of claim 14, in which the beverage medium containing the solubilized amla and the one or more head hair benefit ingredient(s) is a clear solution.

16. The composition of claim 14, in which the beverage medium is water or other aqueous beverage medium.

17. A beverage composition for hydration and for support of head hair health, comprising amla; zinc; selenium; vitamins A-E; and water.

18. The beverage composition of claim 17, having the following weight percentages of ingredients, wherein a total weight percentage of all ingredients in the composition is 100 weight percent:

| Ingredient | Weight Percent |
|---|---|
| chromium | 0.00022% |
| iodine | 0.00055% |
| selenium | 0.00022% |
| zinc | 0.00660% |
| vitamin A | 0.00055% |
| vitamin B | 0.00726% |
| vitamin C | 0.02200% |
| vitamin D | 0.00002% |
| vitamin E | 0.00220% |
| blend | 1.96038% |
| Water | 98.0000.% |
| TOTAL | 100 weight percent |

wherein blend is a blend of plant extracts comprising ashwagandha, amla, reishi mushroom, lion's mane mushroom, holy basil, turmeric root, raspberry juice concentrate, natural flavors, stevia extract, vegetable glycerine, potassium sorbet, and citric acid.

19. A packaged beverage composition for hydration and for support of head hair health, comprising packaging containing the composition of claim 1 in an aqueous beverage medium.

20. A method of concurrently mediating hydration and head hair health of a human subject in need thereof, the method comprising administering to the human subject the composition of claim 1 in an aqueous beverage medium.
